(19) United States
(12) Patent Application Publication
(10) Pub. No.: US 2021/0371038 A1
(43) Pub. Date: Dec. 2, 2021

(54) LIGHT FOLDING SCOOTER WITH FRONT, BACK, LEFT AND RIGHT LIFTING HANDLE POSITIONS

(71) Applicant: Golden Technologies, Inc., Old Forge, PA (US)

(72) Inventors: Hongguo Zeng, Dongguan (CN); Maozhi Qiao, Dongguan (CN)

(21) Appl. No.: 17/171,971

(22) Filed: Feb. 9, 2021

Related U.S. Application Data
(63) Continuation of application No. PCT/CN2019/099928, filed on Aug. 9, 2019.

(30) Foreign Application Priority Data
Aug. 9, 2018 (CN) CN201821280035U
Aug. 9, 2018 (CN) CN201821280980U
Aug. 9, 2018 (CN) CN201821281554U
Aug. 9, 2019 (CN) PCT/CN2019/099928

(51) Int. Cl. B62K 15/00; B62K 5/08

(52) U.S. Cl. CPC B62K 15/006; B62K 5/08

(57) ABSTRACT

A light folding scooter having a bottom plate, and two sides of the bottom plate respectively provided with a lifting handle at a center of gravity of the sides of the scooter after the scooter is folded, and a scooter head and scooter tail of the bottom plate provided with a scooter head lifting handle and a scooter tail groove matched with the scooter head lifting handle for carrying the scooter, wherein the location of the two lifting handles on the sides of the bottom plate at the center of gravity of the scooter after the scooter is folded, allows lifting of the scooter using the two bottom plate lifting handles after being folded by hand can keep balance of a scooter body, which is convenient for carrying the scooter after being folded. When two people lift the scooter, one can locate at the scooter head position to hold the scooter head lifting handle and the other can locate at the scooter tail position to hold the scooter tail groove, so that the scooter can be easily carried. After the product is folded, the occupied space of the scooter body is greatly reduced, and the scooter is convenient to be accommodated on a transportation tool.

### CROSS-REFERENCE TO RELATED APPLICATIONS

This application is a continuation of International Application No. PCT/CN2019/099928, filed Aug. 9, 2019, which claims the benefit of China Application Nos. CN201821281554, CN201821280980, and CN201821280035, all filed Aug. 9, 2018, which applications are incorporated herein by reference in their entireties.

### FIELD OF THE INVENTION

The present invention relates to a transportation tool, and more particularly, to a light folding scooter having front, back, left and right lifting handle positions, a structurally simple and reliable steering T-handle locking mechanism, and a scooter brake releasing mechanism without a handle.

### BACKGROUND

At present, a large number of people, such as disabled people, elderly people, people with limited mobility, etc. need the help of a transportation tool to move. With the development of society and the current situation of an aging society, most families include elderly family members, and in order to facilitate the elderly family members to go out, the transportation tool is needed. The most used transportation tool for disabled and elderly people nowadays is a wheelchair, and a few elderly people use an electric scooter. The main reasons are that the current electric scooter is inconvenient to take along, is difficult to carry, is difficult for elderly people to operate, and is excessively large and heavy, all of which lead to a low utilization rate of the electric scooter. An electric scooter which is convenient to take along and carry is designed now, which can solve the above problems.

In addition, at present, the T-handle steering locking mechanism for an existing electric scooter in the market has a connection between a T-handle fixing seat and a steering arm which is fixed by a middle locking wedge and an upper bolt. The locking wedge is provided with an inclined plane corresponding to the T-handle fixing seat, and an inner hole is provided with a thread matched with the upper bolt. During assembly, the locking wedge would enter into an inner hole in a standpipe of the steering arm, so that when the upper bolt is locked, the inclined plane on the locking wedge and the T-handle fixing seat may be staggered by a certain distance in a diameter direction. Therefore, the locking wedge and a lower portion of the T-handle fixing seat connect the T-handle fixing seat with the steering arm by a friction force generated.

The existing T-handle steering locking mechanism has the following disadvantages.
1. The processing and manufacturing are complex, and machining, stamping, welding and other processes may be implemented, wherein it is difficult to machine a fine thread on a machining standpipe; and the inclined plane and the internal thread are to be machined on the locking wedge and T-handle fixing seat.
2. Functional problems: (a) although there is a tightening washer, a locking nut may still be loosened. (b) The locking is implemented by a friction force of the wedge, which is not rigid after all, if a steering force is excessively large, the locking wedge may slide relative to an inner hole in a steering standpipe, so that a T-handle may be skewed, which is a big defect during use.
3. The structure is complex, there are many parts, a manufacturing process is complex, and the cost is high.
4. The assembly is complex, and the nut must be locked twice, with a high risk of failure.

An existing electric scooter is also generally provided with a mechanical handle at a tail portion of a brake of the scooter, and the handle is pulled to be disengaged from and engaged with a friction plate of the brake, so that it is not difficult to pull the handle, which also affects an aesthetic appearance of the whole scooter. According to the present invention, a switch can be easily pressed to implement the disengagement and engagement of the friction plate of the brake, without affecting the aesthetics of the whole scooter, thus being more convenient for the elderly and disabled people to operate.

### SUMMARY

The present invention is intended to provide a light folding scooter with front, back, left and right lifting handle positions on the scooter bottom plate, a structurally simple and reliable steering T-handle locking mechanism, and a scooter brake releasing mechanism without a handle, aimed at overcoming the above defects in the prior art.

In order to solve the above defects in the prior art, the present invention provides a light folding scooter having a bottom plate, provided with two scooter bottom plate lifting handles located on opposite sides of the scooter bottom plate and at a center of gravity of the scooter when the scooter is folded. In addition, a scooter head of the scooter bottom plate is provided with a scooter head lifting handle, and a scooter tail of the scooter bottom plate is provided with a scooter tail groove matched with the scooter head lifting handle for carrying. A bottom portion of the scooter bottom plate is provided with a front wheel assembly, a rear wheel assembly, and a driving apparatus for driving the rear wheel assembly. The scooter also has a scooter head T-handle having an upper end portion provided with a control apparatus, and the control apparatus is provided with a forward lever, a backward lever, a speed regulating knob, a horn button, a front and rear light switch, and a battery power indicator.

As an improvement of the light folding scooter of the present invention, the scooter bottom plate lifting handles are integrally formed with the scooter bottom plate, and each scooter bottom plate lifting handle is a hollow scooter bottom plate lifting handle which is formed by opening a through hole on two sides of the scooter bottom plate.

As another improvement of the light folding scooter, an edge of the scooter bottom plate lifting handle is flush with a side portion of the scooter bottom plate.

As another improvement of the light folding scooter, the scooter head of the scooter bottom plate is provided with a scooter head steering T-handle foldable along a tail portion of the scooter bottom plate, and a foldable seat supporting frame is arranged on an upper plane of the scooter bottom plate close to the positions of the left and right lifting handles of the scooter bottom plate.

As another improvement of the light folding scooter, one side of the seat supporting frame is provided with two or more T-handle head locks for folding and clamping the scooter head steering T-handle.

As another improvement of the light folding scooter, the T-handle head lock is made of rubber, silica gel, or plastic, and an end portion of the T-handle head lock is provided with a U-shaped, C-shaped, or semicircular bulge.

As another improvement of the light folding scooter, the scooter head steering T-handle is folded along the tail portion of the scooter bottom plate, and then clamped and fixed with the two T-handle head locks.

Compared with the prior art, the light folding scooter of the present invention has the advantage that the two sides of the scooter bottom plate are respectively provided with a scooter bottom plate lifting handle, and the two scooter bottom plate lifting handles are both located at the center of gravity of the scooter after the scooter being folded. When the scooter is to be carried, first the seat supporting frame is folded and laid flat on the scooter bottom plate, and then the scooter head T-handle is folded and is clamped on the two handle head locks of the seat supporting frame for fixing the scooter head T-handle to the scooter bottom plate, thus preventing the scooter head T-handle from swinging. Since the two scooter bottom plate lifting handles are located on the two sides of the scooter bottom plate and at the center of gravity of the scooter after the scooter is folded, lifting the scooter using the left or right lifting handle of the scooter bottom plate by hand can keep balance of a scooter body after the scooter is folded, which is convenient for carrying. The folded scooter can also be taken flat by two hands conveniently. The scooter head of the scooter bottom plate is provided with the scooter head lifting handle, and the scooter tail of the scooter bottom plate is provided with the scooter tail groove matched with the scooter head lifting handle for carrying. When two people lift the scooter, one can locate at the scooter head position to hold the scooter head lifting handle and the other can locate at the scooter tail position to hold the scooter tail groove, so that the scooter can be easily lifted and carried. After the scooter is folded, an occupied space of a scooter body can be greatly reduced, and the scooter is convenient to be accommodated on a transportation tool.

The present invention also provides a folding scooter with a structurally simple and reliable steering T-handle locking mechanism which includes the scooter bottom plate a scooter head T-handle, wherein a frame sleeve is arranged at the scooter head of the scooter bottom plate, a T-handle fixing seat is arranged at a bottom portion of the T-handle, a lower end of the T-handle fixing seat is fixedly connected with a steering arm through a fixing bolt, an upper end of the steering arm penetrates into a bottom portion of the frame sleeve and is fixedly clamped with the lower end of the T-handle fixing seat, and the fixing bolt penetrates into the upper end of the steering arm from the bottom portion of the steering arm and is connected with a nut at the lower end of the T-handle fixing seat.

As an improvement of the scooter steering T-handle locking mechanism of the present invention, the lower end of the T-handle fixing seat is provided with a connecting sleeve, a hexagonal socket for mounting the hexagonal locknut and an internal spline are arranged in the connecting sleeve, the hexagonal socket is located above the internal spline, and the fixing bolt penetrates into the upper end of the steering arm from the bottom portion of the steering arm and is screwed with the hexagonal locknut.

As another improvement of the scooter steering T-handle locking mechanism, the upper end of the steering arm is provided with an external spline, and the external spline penetrates into the bottom portion of the frame sleeve and is clamped with the internal spline.

As another improvement of the scooter steering T-handle locking mechanism, the upper end of the frame sleeve is provided with an upper bowl set for mounting the T-handle fixing seat, and the lower end of the frame sleeve is provided with a lower bowl set for mounting the steering arm.

As another improvement of the scooter steering T-handle locking mechanism, the bottom portion of the steering arm is provided with a steering plate, and two ends of the steering plate are respectively connected with two front wheels through connecting rods.

As another improvement of the scooter steering T-handle locking mechanism, the upper end of the T-handle fixing seat is provided with a Y-shaped connecting seat, and the Y-shaped connecting seat is connected with a T-handle through a bolt.

Compared with the prior art, the locking mechanism of the T-handle fixing seat and the steering arm of the folding scooter has the advantages that the T-handle fixing seat and the steering arm are directly connected and locked through the fixing bolt and the hexagonal locknut, wherein the lower end of the T-handle fixing seat is provided with an internal spline matched with the steering arm, the upper end is internally provided with the hexagonal socket matched with the hexagonal locknut, and the socket prevents the hexagonal locknut from rotating. The upper end of the steering arm is provided with the external spline matched with the T-handle fixing seat, and after assembly, the T-handle fixing seat is matched with the internal and external splines of the steering arm, and then locked by the fixing bolt and the hexagonal locknut.

The steering T-handle locking mechanism of the present invention also has the following advantages.
1. The locking mechanism is simple to process, and the T-handle fixing seat and the steering arm are both formed through a mold in a single process, and do not need to be subjected to secondary processing.
2. The locking mechanism works reliably, with a structure of an internal spline and an external spline to transmit torque, thus avoiding a slipping phenomenon.
3. The locking mechanism is simple in structure, has fewer parts, is simple to machine and manufacture, which is formed through a mold in a single process, and has a lower cost.
4. The invention is simple to assemble, and only a single locking step through the hexagonal locknut is needed.

The present invention also provides a scooter brake releasing mechanism without a handle, wherein the bottom portion of the scooter head of the scooter bottom plate is provided with a front wheel assembly, and the tail portion of the scooter bottom plate is provided with a rear wheel assembly and a driving apparatus for driving the rear wheel assembly. The tail portion of the scooter bottom plate is also provided with an electromagnetic brake and a six-pin rocker switch used for controlling the electromagnetic brake to implement on-off braking. When the six-pin rocker switch is switched on, the electromagnetic brake releases restriction on the rear wheel assembly, and when the six-pin rocker switch is switched off, the electromagnetic brake restricts rotation of the rear wheel assembly. The six-pin rocker switch is connected with two terminals of a controller and two poles of a battery. A first pin to a sixth pin are arranged on the six-pin rocker switch, such that when the six-pin rocker switch is switched to the first pin and the fourth pin, the electromagnetic brake is directly powered by the battery, a purpose of releasing is also achieved, and a circuit of the related brake in the controller is cut off at the same time; and one terminal of the controller is connected to the third pin, the other terminal of the controller is connected to the sixth pin, an anode of the battery is connected to the fourth pin, and a cathode of the battery is connected to the first pin.

As an improvement of the scooter brake releasing mechanism without the handle, when the electromagnetic brake restricts the rotation of the rear wheel assembly, the rear wheel assembly rotates only after the six-pin rocker switch is switched on.

As another improvement of the scooter brake releasing mechanism without the handle, the driving apparatus includes a motor and a reduction gearbox, an output shaft of the motor drives a gear set in the reduction gearbox to drive, and the gear set in the reduction gearbox drives the rear wheel assembly to move.

As another improvement of the scooter brake releasing mechanism without the handle, the electromagnetic brake is arranged at the other end of the output shaft of the motor; when the six-pin rocker switch is switched on, a friction plate of the electromagnetic brake is disengaged from the output shaft of the motor, the motor is capable of rotating under pushing by an external force, and when the six-pin rocker switch is switched off, the friction plate of the electromagnetic brake is connected to the output shaft of the motor, the friction plate restricts a movement of the motor, and the motor is incapable of rotating under the pushing by the external force.

As another improvement of the scooter brake releasing mechanism without the handle, the scooter head of the scooter bottom plate is provided with a steering control handle for controlling steering of the front wheel assembly, a bearing is arranged at a joint between a lower end of the steering control handle and the scooter bottom plate, the lower end of the steering control handle is provided with a steering arm, and the steering arm is connected with the front wheel assembly.

As another improvement of the scooter brake releasing mechanism without the handle, the front wheel assembly includes two front wheels, and the two front wheels are both connected with the steering arm through a steering connecting rod.

As another improvement of the scooter brake releasing mechanism without the handle, the steering connecting rod includes left and right steering arms connected to the front wheel and connecting rods connected to the steering arms, the connecting rods are connected with the left and right steering arms through a rotating pin, an extension block is arranged on the steering arm, one end of the extension block is provided with two symmetrical holes, and one ends of the two connecting rods are respectively fixed by a bolt.

As another improvement of the scooter brake releasing mechanism without the handle, a foldable seat bracket is also arranged on the scooter bottom plate, a seat is arranged on the seat bracket, both sides of the seat are provided with an armrest, the armrest is capable of rotating by 90 degrees towards a backrest; and a bottom portion of the seat is provided with a sleeve for mounting the armrest, a V-shaped groove and a bump are arranged at an opening of the sleeve, one end of the armrest penetrates through the sleeve and a reset spring is sleeved on a penetrated portion, and a stop pin is arranged at a position of the armrest in the V-shaped groove.

Compared with the prior art, the invention has the advantages that the tail portion of the scooter bottom plate is provided with the six-pin rocker switch and the electromagnetic brake, such that when the six-pin rocker switch is switched on, the electromagnetic brake releases restriction on the rear wheel assembly, and when the six-pin rocker switch is switched off, the electromagnetic brake restricts rotation of the rear wheel assembly. The friction plate of the electromagnetic brake is connected to the output shaft of the motor, the friction plate restricts the movement of the motor, and the motor is incapable of rotating under the pushing by the external force. Only after the power supply of the scooter is switched on, the electromagnetic brake can be powered again, and the friction plate is disengaged from the output shaft of the motor again, so that the motor is unlocked and may be operated normally.

A circuit control principle is that: when the six-pin rocker switch is switched on, the electromagnetic brake is directly powered by the battery, so that a purpose of releasing is also achieved, and a circuit of the related brake in the controller is cut off at the same time, so that the controller cannot work normally, and the scooter can only be pushed. According to the product, the scooter body can be conveniently moved under a condition that a controller power supply is not switched on. A handle and other mechanisms are canceled in the electromagnetic brake, which greatly reduces a cost of the brake. When switching modes, it is much easier to move a switch button than a handle.

### BRIEF DESCRIPTION OF THE DRAWINGS

The present invention and the beneficial technical effects are further described in detail hereinafter with reference to the accompanying drawings and the specific implementations, wherein:

FIG. 1 is a perspective view of a folding scooter in accordance with the present invention;

FIG. 2 is a perspective view of the folding scooter shown in FIG. 1 with the seat removed;

FIG. 3 is a perspective view of the folding scooter in a folded position;

FIG. 4 is a top view of the folding scooter in a folded position;

FIG. 5 is an exploded view of the t-handle locking mechanism of the folding scooter;

FIG. 6 is a cross-sectional view of a T-handle position of the folding scooter;

FIG. 7 is a schematic view of a T-handle fixing seat;

FIG. 8 is a bottom portion of the T-handle fixing seat;

FIG. 9 is a top view of the T-handle fixing seat;

FIG. 10 is a schematic view of a structure of a steering arm.

FIG. 11 is a bottom view of the folding scooter; and

FIG. 12 is a principle diagram of a circuit of the scooter brake releasing mechanism.

### DETAILED DESCRIPTION

The present invention is further described hereinafter with reference to the accompanying drawings and the specific embodiments, but the implementations of the present invention are not limited thereto.

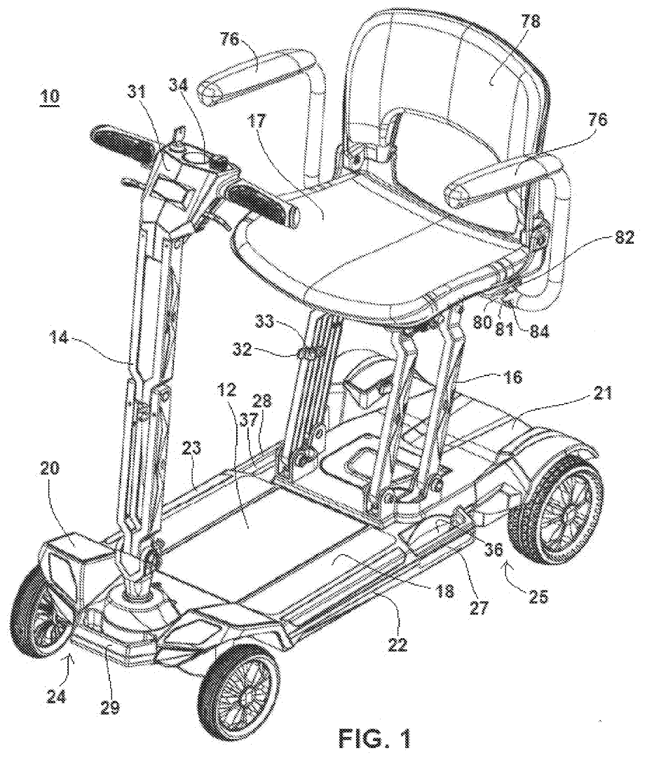

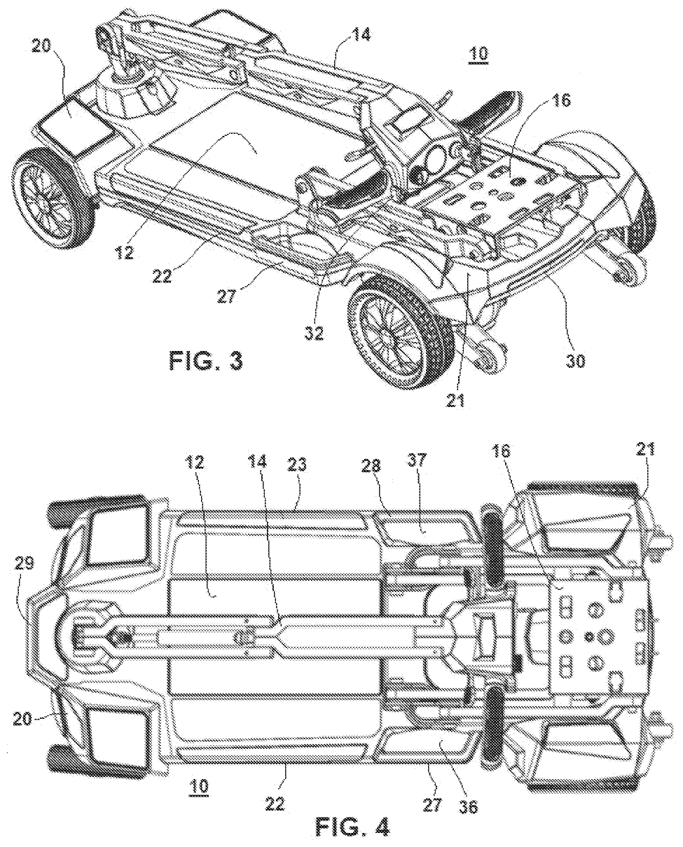

As shown in FIGS. 1-5 and 11, a light folding scooter 10 in accordance with the present invention generally includes a scooter body including a scooter bottom plate 12, a scooter head t-handle 14, and a foldable seat supporting frame 16 which supports seat 17. The scooter bottom plate 12 has an upper portion 18, a bottom portion 19, a scooter head portion 20, a scooter tail portion 21, and opposite side portions 22 and 23. As best shown in FIG. 11, the scooter head portion 20 of scooter bottom plate 12 is provided with a front wheel assembly 24 on bottom portion 19, and the scooter tail portion 21 is similarly provided with a rear wheel assembly 25 and a driving apparatus 26 for driving the rear wheel assembly 25 on bottom portion 19. The scooter head portion 20 of the scooter bottom plate 12 is preferably provided with the scooter head steering T-handle 14 which as shown in FIGS. 3 and 4 is foldable along the tail portion 21 of the scooter bottom plate 12. A side bottom plate lifting handle 27 is provided on side portion 22 of scooter bottom plate 12, and another side bottom plate lifting 28 is provided on side portion 23 of scooter bottom plate 12. In addition, a scooter head lifting handle 29 is provided on head portion 20 of scooter bottom plate 12, and a scooter tail groove 30 is provided on tail portion 21 of scooter bottom plate 12 matched with the scooter head lifting handle 29 for carrying.

Foldable seat supporting frame 16 is arranged on an upper plane of upper portion 18 of the scooter bottom plate 12 close to the positions of the lifting handles 27 and 28 on side portions 22 and 23, respectively Preferably, one side of the seat supporting frame 16 is provided with two or more T-handle head locks 32. The scooter head steering T-handle 14 also preferably folds along the tail portion 21 of the scooter bottom plate 12, and then is clamped and fixed with the T-handle head locks 32. The T-handle head locks 32 are preferably made of rubber, silica gel, or plastic, and an end portion of the T-handle head lock 32 is provided with a U-shaped, C-shaped, or semicircular bulge 33. The T-handle head locks 32 can limit a movement of the scooter head steering T-handle 14 through a friction force between a colloid and the scooter head lifting handle.

An upper end portion of the scooter head steering T-handle 14 is provided with a control apparatus 34, and the control apparatus 34 is provided with a forward lever, a backward lever, a speed regulating knob, a horn button, a front and rear light switch, and a battery power indicator. When the forward lever is pulled backward, the driving apparatus 26 controls the rear wheel assembly 25 to move forward, and when the backward lever is pulled backward, the driving apparatus 26 controls the rear wheel assembly 25 to move backward.

Preferably, the scooter bottom plate lifting handles 27 and 28 are integrally formed with the scooter bottom plate 12, and the handles 27 and 28 are hollow scooter bottom plate lifting handles which are formed by opening through-holes 36 and 37 on the scooter side portions 22 and 23 of the scooter bottom plate 12. By integrally forming the scooter bottom plate lifting handles 27 and 28 with the scooter bottom plate 12, the firmness of the scooter bottom plate lifting handles 27 and 28 is improved. Preferably, an edge of the scooter bottom plate lifting handles 27 and 28 is flush with a side edge of side portions 22 and 23 of the scooter bottom plate 12. There is no excess or additional portion required in forming the handles 27 and 28, which reduces the space of the scooter body. The scooter bottom plate lifting handles 27 and 28 are both located at a center of gravity of the scooter bottom plate 12 when the scooter 10 is folded. In addition, the scooter head lifting handle 29 on head portion 20 of the scooter bottom plate 12 is matched with the scooter tail groove 30 on the tail portion 21 of the scooter bottom plate 12 for carrying. According to the present invention, therefore, the two opposite side portions 22 and 23 of the scooter bottom plate 12 are respectively provided with a scooter bottom plate lifting handle 27 and 28, which two scooter bottom plate lifting handles 27 and 28 are both located at the center of gravity of the scooter 10 after the scooter 10 is folded.

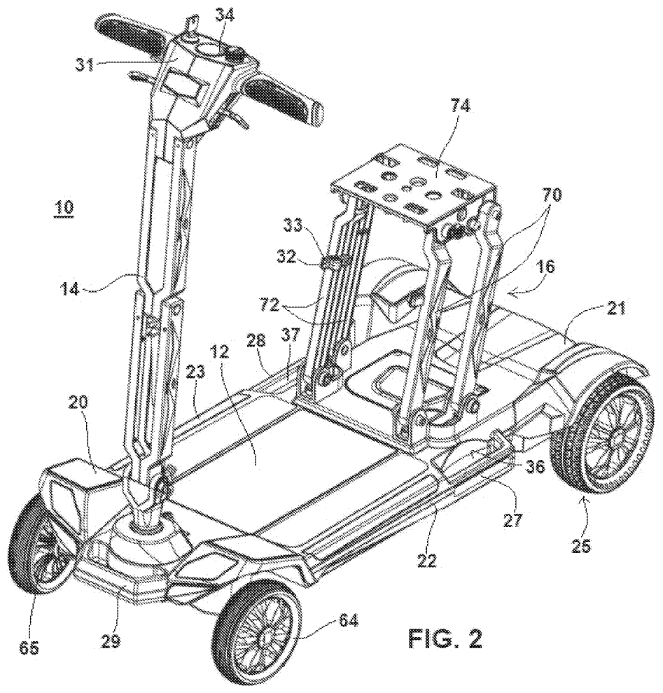

When the folding scooter 10 is to be carried, as shown in FIG. 2, first the seat 17 is removed from the seat supporting frame 16, and the seat supporting frame 16 is folded and laid flat on the scooter bottom plate 12. Then, as shown in FIG. 3, the scooter head T-handle 14 is folded, so that the control apparatus 30 at a head portion 28 of the scooter head T-handle 14 is clamped on the two handle head locks 32 of the seat supporting frame 16 for fixing, thus preventing the scooter head T-handle 14 from swinging. Since the two opposite scooter bottom plate lifting handles 27 and 28 are located at the center of gravity of the two sides of the scooter bottom plate 12, manually lifting the scooter 10 using either of the two scooter bottom plate lifting handles 27 and 28 can keep the balance of the scooter body, which is convenient for carrying. The scooter head portion 20 of the scooter bottom plate 12 is provided with the scooter head lifting handle 29, and the scooter tail 21 of the scooter bottom plate 12 is provided with the scooter tail groove 30 which is matched with the scooter head lifting handle 29 for carrying. When two people manually lift the scooter 10, one can locate at the scooter head position to hold the scooter head lifting handle 29 and the other can locate at the scooter tail position to hold the scooter tail groove 30, so that the scooter 10 can be easily lifted and carried. After the scooter 10 is folded, the space occupied by the scooter body will be greatly reduced, and the scooter 10 is convenient to be accommodated on a transportation tool.

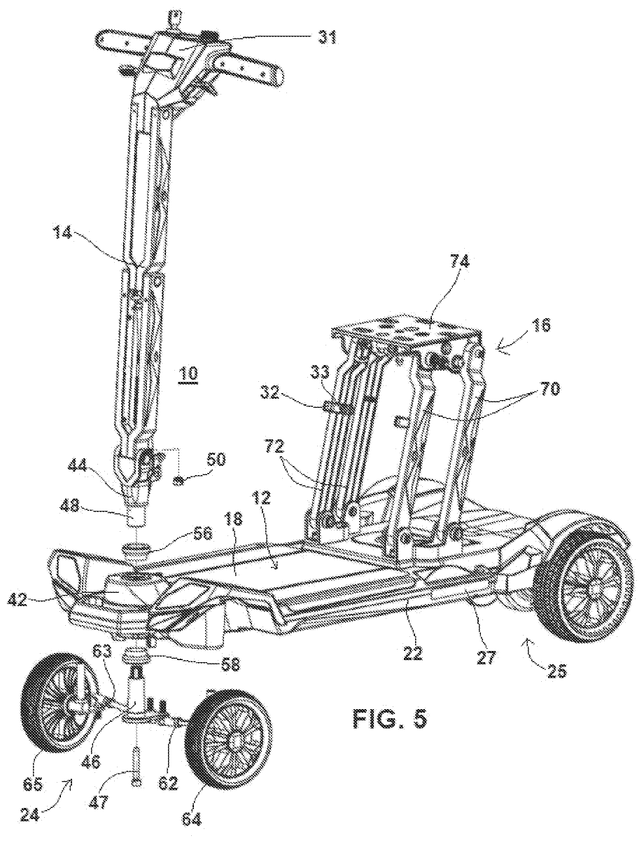

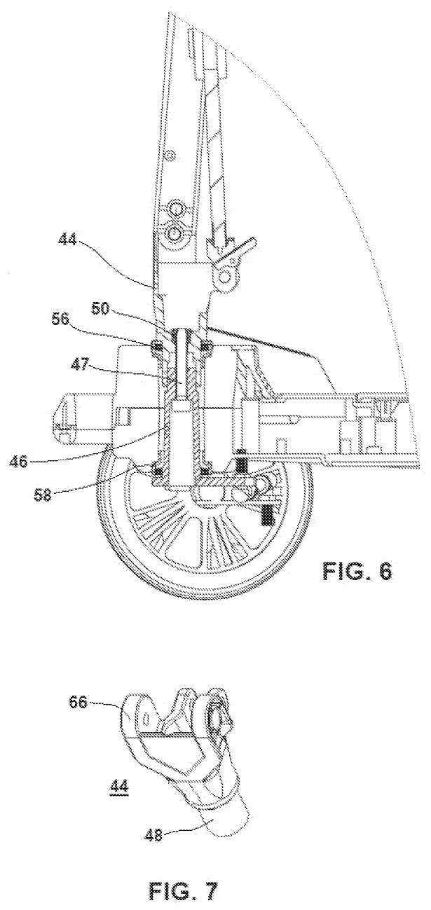

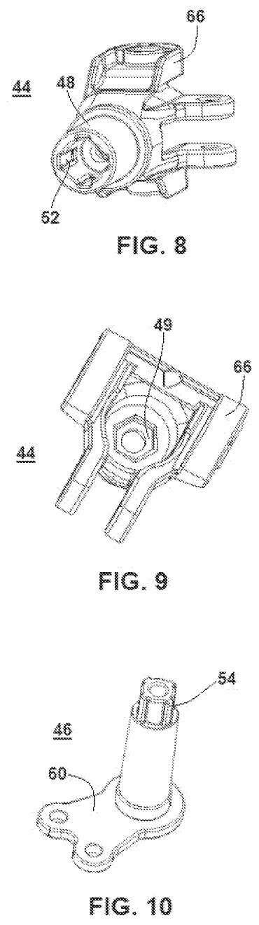

Referring now in particular to FIGS. 5-10, the folding scooter also provides a steering T-handle locking mechanism for locking the scooter steering T-handle 14 with respect to the scooter bottom plate 12. A frame sleeve 42 is arranged at the scooter head 20 on the upper portion 18 of the scooter bottom plate 12, and a T-handle fixing seat 44 is arranged at a bottom portion of the steering T-handle 14. A lower end of the T-handle fixing seat 44 is fixedly connected with a steering arm 46 through a fixing bolt 47, an upper end of the steering arm 46 penetrates into a bottom portion of the frame sleeve 42 and is fixedly clamped with the lower end of the T-handle fixing seat 44, and the fixing bolt 47 penetrates into the upper end of the steering arm 46 from the bottom portion of the steering arm 46 and is connected with a nut at the lower end of the T-handle fixing seat 44.

More particularly, preferably the lower end of the T-handle fixing seat 44 is provided with a connecting sleeve 48, and, as best shown in FIG. 9, a hexagonal socket 49 for mounting a hexagonal locknut 50 and an internal spline 52 are arranged in the connecting sleeve 48, with the hexagonal socket 49 located above the internal spline 52. The fixing bolt 47 for the steering arm 46 penetrates into the upper end of the steering arm 46 from the bottom portion of the steering arm 46 and is screwed with the hexagonal locknut 49. Preferably, as best shown in FIG. 10, the upper end of the steering arm 46 is provided with an external spline 54, which external spline 54 penetrates into the bottom portion of the frame sleeve 42 and is clamped with the internal spline 52 in connecting sleeve 48 on the lower end of the T-handle fixing seat 44. Preferably, the upper end of the frame sleeve 42 is provided with an upper bowl set 56 for mounting the T-handle fixing seat 44, and the lower end of the frame sleeve 42 is provided with a lower bowl set 58 for mounting the steering arm 46. Preferably, as shown in FIGS. 5 and 10, the bottom portion of the steering arm 46 is provided with a steering plate 60, and two ends of the steering plate 60 are respectively connected with two front wheels 64 and 65 through connecting rods 62 and 63. In addition, as shown in FIG. 7, preferably the upper end of the T-handle fixing seat 44 is provided with a Y-shaped connecting seat 66, and the Y-shaped connecting seat 66 is connected with the steering T-handle 14 through a bolt passed through mating apertures in the Y-shaped connecting seat 66 and lower end of the steering T-handle 14.

According to the present invention, the locking mechanism of the T-handle fixing seat 44 and the steering arm 46 is that the T-handle fixing seat 44 and the steering arm 46 are directly connected and locked through the fixing bolt 47 and the hexagonal locknut 50, wherein the lower end of the T-handle fixing seat 44 is provided with a connecting sleeve 48 having an internal spline 52 matched with the external spline 54 on the upper end of the steering arm 46, and the upper end of the T-handle fixing seat 46 is internally provided with the hexagonal socket 49 matched with the hexagonal locknut 50, wherein the hexagonal socket 49 prevents the hexagonal locknut 50 from rotating. The upper end of the steering arm 46 is provided with the external spline 54 matched with the internal splines 52 of the T-handle fixing seat 44, and after assembly, the internal splines 52 of the T-handle fixing seat 44 are matched with the external splines of the steering arm 46, and then locked by the fixing bolt 47 and the hexagonal locknut 50.

As shown in FIG. 2, foldable seat supporting frame 16 mounted to the upper portion 18 of the scooter bottom plate 12 includes pairs of front and rear legs 70 and 72. A seat platform 74 is connected to an outer end of the legs 70 and 72, and as shown in FIG. 1 seat 17 is mounted to the seat platform 74. Two sides of the seat 17 are provided with an armrest 76, and the armrest 76 is capable of rotating by 90 degrees in a direction of a backrest 78.

A bottom portion of the seat 17 is provided with a sleeve 80 for mounting the armrest 76, and a V-shaped groove 81 and a bump 82 are arranged at an opening of the sleeve 80. One end of the armrest 76 penetrates through the sleeve 80 and a reset spring is sleeved on a penetrated portion, and a stop pin 84 is arranged at a position of the armrest 76 and 77 in the V-shaped groove 81. When the armrest 76 rotates upwardly, the stop pin 84 gradually slides out of the V-shaped groove 81 and finally abuts against the bump 82 for positioning.

The folding scooter 10 also has a novel scooter brake releasing mechanism without a handle. As shown in FIG. 11, the tail portion 21 of scooter bottom plate 12 on bottom portion 19 is provided with an electromagnetic brake 84 and a six-pin rocker switch 86 used for controlling the electromagnetic brake 84 to implement on-off braking. When the six-pin rocker switch 86 is switched on, the electromagnetic brake 84 releases restriction on the rear wheel assembly 25, and when the six-pin rocker switch 86 is switched off, the electromagnetic brake 84 restricts rotation of the rear wheel assembly 25. Preferably, when the electromagnetic brake 84 restricts the rotation of the rear wheel assembly 25, the rear wheel assembly 25 rotates only after the six-pin rocker switch 86 is switched on.

Preferably, the driving apparatus 26 for the rear wheel assembly 25 includes a motor 88 and a reduction gearbox 90. An output shaft of the motor 88 drives a gear set in the reduction gearbox 90 to drive, and the gear set in the reduction gearbox 90 drives the rear wheel assembly 25 to move. The electromagnetic brake 84 is preferably arranged at the other end of the output shaft of the motor 88. When the six-pin rocker switch 86 is switched on, a friction plate of the electromagnetic brake 84 is disengaged from the output shaft of the motor 88, and the motor 88 is capable of rotating under pushing by an external force. When the six-pin rocker switch 86 is switched off, the friction plate of the electromagnetic brake 84 is connected to the output shaft of the motor 88, the friction plate restricts a movement of the motor 88, and the motor 88 is incapable of rotating under the pushing by the external force.

Steering control T-handle 14 for controlling steering of the front wheel assembly 24 is provided on the head portion 20 of the scooter bottom plate 12. A bearing is arranged at a joint between a lower end of the steering control T-handle 14 and the scooter bottom plate 12, the lower end of the steering control T-handle 14 is provided with a steering arm 46, and the steering arm 46 is connected with the front wheel assembly 24 as described above. Preferably, the front wheel assembly 24 includes two front wheels 64 and 65, and the two front wheels 64 and 65 are each connected with the steering arm 46 through a steering connecting rod 62 and 63, respectively.

Preferably, the steering connecting rods 62, 63 include left and right steering arms 92, 93 which are connected to front wheel 64, 65, respectively, and connecting rods 94, 95 which connect between the steering arms 92, 93 and the steering arm 46. More particularly, the connecting rods 94, 95 are connected with the left and right steering arms 92, 93 through a rotating pin, an extension block 60 is arranged on the steering arm 46, one end of the extension block or steering plate 60 is provided with two symmetrical holes 96, and one end of the two connecting rods 94, 95 are respectively fixed in the holes 96 by a bolt.

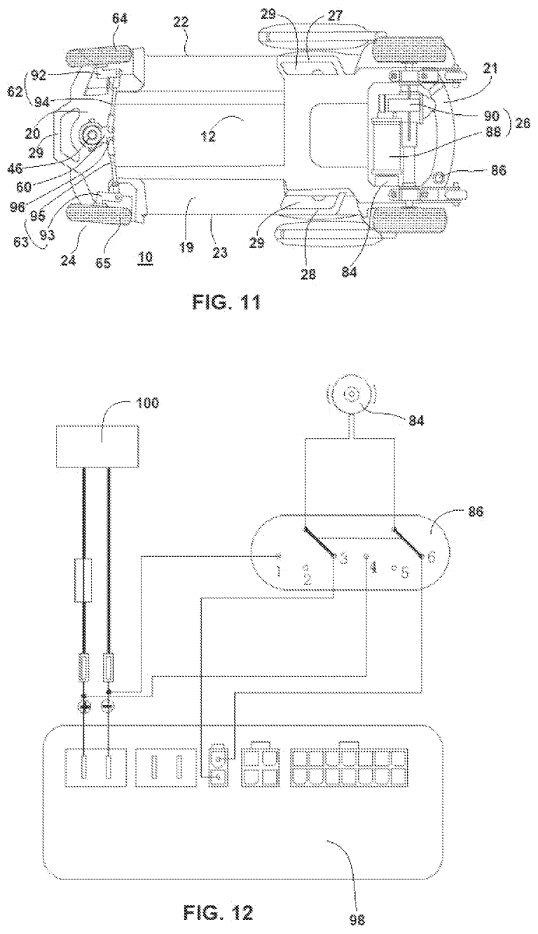

As shown in FIG. 12, the six-pin rocker switch 86 is electrically connected with two terminals of the controller 98 and two poles (an anode and a cathode) of the battery 100. A first pin 1 to a sixth pin 6 are arranged on the six-pin rocker switch 86 such that when the six-pin rocker switch 86 is switched to the first pin 1 and the fourth pin 4, the electromagnetic brake 84 is directly powered by the battery 100, a purpose of releasing is also achieved, and a circuit of the related brake in the controller 98 is cut off at the same time, so that the controller 98 cannot work normally, and the scooter can only be pushed. One terminal of the controller 98 is connected to the third pin 3, the other terminal of the controller 98 is connected to the sixth pin 6. The anode of the battery 100 is connected to the fourth pin 4, and the cathode of the battery 100 is connected to the first pin 1.

According to the present invention, the tail portion 21 of the scooter bottom plate 12 is therefore provided with the six-pin rocker switch 86 and electromagnetic brake 84, and when the six-pin rocker switch 86 is switched on, the electromagnetic brake 84 releases restriction on the rear wheel assembly 25, and when the six-pin rocker switch 86 is switched off, the electromagnetic brake 84 restricts rotation of the rear wheel assembly 25. The friction plate of the electromagnetic brake 84 is connected to the output shaft of the motor 88, the friction plate restricts the movement of the motor 88, and the motor 88 is incapable of rotating under the pushing by the external force. Only after the power supply of the scooter 10 is switched on, the electromagnetic brake 84 can be powered again, and the friction plate is disengaged from the output shaft of the motor 88 again, so that the motor 88 is in unlocked and may be operated normally. The scooter is provided with the six-legged ship-shaped switch at the scooter tail, which may restrict the movement of the scooter body during parking, and improve a braking effect of the scooter. According to the product, the scooter body can be conveniently moved under a condition that a motor power supply is not switched on.

Although embodiments of the present invention have been shown and described, it is understood by those skilled in the art that various changes, modifications, substitutions and variations may be made to these embodiments without departing from the principle and structure of the invention.

1. A light folding scooter with front, back, left and right lifting handle positions, comprising a scooter bottom plate, wherein two sides of the scooter bottom plate are respectively provided with a scooter bottom plate lifting handle, the two scooter bottom plate lifting handles are both located on the two sides of the scooter bottom plate, and at a center of gravity of the scooter after the scooter is folded, a scooter head of the scooter bottom plate is provided with a scooter head lifting handle, and a scooter tail of the scooter bottom plate is provided with a scooter tail groove matched with the scooter head lifting handle for carrying.

2. The light folding scooter with front, back, left and right lifting handle positions according to claim 1, wherein the scooter bottom plate lifting handle is integrally formed with the scooter bottom plate, and the scooter bottom plate lifting handle is a hollow scooter bottom plate lifting handle which is formed by opening a through hole on two sides of the scooter bottom plate.

3. The light folding scooter with front, back, left and right lifting handle positions according to claim 2, wherein an edge of the scooter bottom plate lifting handle is flush with a side portion of the scooter bottom plate.

4. The light folding scooter with front, back, left and right lifting handle positions according to claim 1, wherein the scooter head of the scooter bottom plate is provided with a scooter head steering T-handle foldable along a tail portion of the scooter bottom plate, and a foldable seat supporting frame is arranged on an upper plane of the scooter bottom plate close to positions of the left and right lifting handles of the scooter bottom plate.

5. The light folding scooter with front, back, left and right lifting handle positions according to claim 4, wherein one side of the seat supporting frame is provided with two or more handle head locks for folding and clamping the scooter head steering T-handle.

6. The light folding scooter with front, back, left and right lifting handle positions according to claim 5, wherein the handle head lock is made of rubber, silica gel, or plastic, and an end portion of the handle head lock is provided with a U-shaped, C-shaped, or semicircular bulge.

7. The light folding scooter with front, back, left and right lifting handle positions according to claim 5, wherein the scooter head steering T-handle is folded along the tail portion of the scooter bottom plate, and then clamped and fixed with the two handle head locks.

8. A scooter with a structurally simple and reliable steering T-handle locking mechanism, comprising a scooter bottom plate and a T-handle, wherein a frame sleeve is arranged at a scooter head of the scooter bottom plate, a T-handle fixing seat is arranged at a bottom portion of the T-handle, a lower end of the T-handle fixing seat is fixedly connected with a steering arm through a fixing bolt, an upper end of the steering arm penetrates into a bottom portion of the frame sleeve and is fixedly clamped with the lower end of the T-handle fixing seat, and the fixing bolt penetrates into the upper end of the steering arm from the bottom portion of the steering arm and is connected with a nut at the lower end of the T-handle fixing seat.

9. The scooter with the structurally simple and reliable steering T-handle locking mechanism according to claim 1, wherein the lower end of the T-handle fixing seat is provided with a connecting sleeve, a hexagonal socket for mounting the hexagonal locknut and an internal spline are arranged in the connecting sleeve, the hexagonal socket is located above the internal spline, and the fixing bolt penetrates into the upper end of the steering arm from the bottom portion of the steering arm and is screwed with the hexagonal locknut.

10. The scooter with the structurally simple and reliable steering T-handle locking mechanism according to claim 2, wherein the upper end of the steering arm is provided with an external spline, and the external spline penetrates into the bottom portion of the frame sleeve and is clamped with the internal spline of the T-handle fixing seat.

11. The scooter with the structurally simple and reliable steering T-handle locking mechanism according to claim 3, wherein the upper end of the frame sleeve is provided with an upper bowl set for mounting the T-handle fixing seat, and the lower end of the frame sleeve is provided with a lower bowl set for mounting the steering arm.

12. The scooter with the structurally simple and reliable steering T-handle locking mechanism according to claim 1, wherein the bottom portion of the steering arm is provided with a steering plate, and two ends of the steering plate are respectively connected with two front wheels through connecting rods.

13. The scooter with the structurally simple and reliable steering T-handle locking mechanism according to claim 1, wherein the upper end of the T-handle fixing seat is provided with a Y-shaped connecting seat, and the Y-shaped connecting seat is connected with a T-handle through a bolt.

14. A scooter brake releasing mechanism without a handle, comprising a scooter bottom plate, wherein a bottom portion of a scooter head of the scooter bottom plate is provided with a front wheel assembly, a tail portion of the scooter bottom plate is provided with a rear wheel assembly and a driving apparatus for driving the rear wheel assembly, the tail portion of the scooter bottom plate is also provided with an electromagnetic brake and a six-pin rocker switch used for controlling the electromagnetic brake to implement on-off braking, when the six-pin rocker switch is switched on, the electromagnetic brake releases restriction on the rear wheel assembly, and when the six-pin rocker switch is switched off, the electromagnetic brake restricts rotation of the rear wheel assembly.

15. The scooter brake releasing mechanism without the handle according to claim 1, wherein when the electromagnetic brake restricts the rotation of the rear wheel assembly, the rear wheel assembly rotates only after the six-pin rocker switch is switched on.

16. The scooter brake releasing mechanism without the handle according to claim 2, wherein the driving apparatus comprises a motor and a reduction gearbox, an output shaft of the motor drives a gear set in the reduction gearbox to drive, and the gear set in the reduction gearbox drives the rear wheel assembly to move.

17. The scooter brake releasing mechanism without the handle according to claim 3, wherein the electromagnetic brake is arranged at the other end of the output shaft of the motor; when the six-pin rocker switch is switched on, a friction plate of the electromagnetic brake is disengaged, the motor is capable of rotating under pushing by an external force, when the six-pin rocker switch is switched off, the friction plate of the electromagnetic brake is engaged, the friction plate restricts a movement of the motor, and the motor is incapable of rotating under the pushing by the external force.

18. The scooter brake releasing mechanism without the handle according to claim 1, wherein the scooter head of the scooter bottom plate is provided with a steering control handle for controlling steering of the front wheel assembly, a bearing is arranged at a joint between a lower end of the steering control handle and the scooter bottom plate, the lower end of the steering control handle is provided with a steering arm, and the steering arm is connected with the front wheel assembly.

19. The scooter brake releasing mechanism without the handle according to claim 5, wherein the front wheel assembly comprises two front wheels, and the two front wheels are both connected with the steering arm through a steering connecting rod.

20. The scooter brake releasing mechanism without the handle according to claim 6, wherein the steering connecting rod comprises left and right steering arms connected to the front wheel and connecting rods connected to the steering arms, the connecting rods are connected with the left and right steering arms through a rotating pin, an extension block is arranged on the steering arm, one end of the extension block is provided with two symmetrical clamping grooves, and one end of the two connecting rods are respectively inserted into the clamping grooves for fixing.

21. (canceled)

22. (canceled)
